(19) United States
(12) Patent Application Publication
(10) Pub. No.: US 2011/0319162 A1
(43) Pub. Date: Dec. 29, 2011

(54) GREETING CARDS AND SOCIAL COMMUNICATION PRODUCTS WITH VIDEO GAMING FEATURES

(76) Inventors: Keith Corcoran, Brunswick, OH (US); David Mayer, Bay Village, OH (US); Seth Larson, Lakewood, OH (US); Terry Hughes, Avon, OH (US); Jerry Guo, Shanghai (CN)

(21) Appl. No.: 13/172,215

(22) Filed: Jun. 29, 2011

Related U.S. Application Data
(60) Provisional application No. 61/359,522, filed on Jun. 29, 2010.

(51) Int. Cl. A63F 13/00; G09F 1/00

(52) U.S. Cl. 463/31

(57) ABSTRACT

The greeting card of the present disclosure and related inventions includes a mini video game enclosed within the greeting card construct. The video game screen and control buttons can be accessed through the card construct, either through the front face of the greeting card or through an internal panel. The video game components are concealed and protected within a protective housing that is substantially contained within the panels of the greeting card construct. An on/off switch may be included so that a user or card recipient can control power to the game or a slide or other type of switch may be included to automatically turn on the video game.

### RELATED APPLICATIONS

This application claims priority to U.S. Provisional Patent Application Ser. No. 61/359,522, filed on Jun. 29, 2010, which is incorporated herein in its entirety.

### FIELD OF THE INVENTION

The present invention is in the general field of social entertainment and multi-media products and devices.

### BACKGROUND OF THE INVENTION

The digital age, created by the advent of personal computers, compact digital electronics and multi-media content has made people very accustomed to digital communication and messages. While multi-media content, such as digital images, sound and animation is predominantly distributed and accessed over networks such as television and cable and wireless communication networks, and over the Internet via the world wide web, and received and viewed on various types of monitors, it is increasingly accessed and viewed on smaller and portable devices such as personal digital assistants (PDA), wireless telephones with screen displays, and flat panel displays such as monitors and digital photo frames. Multi-media content is extremely diverse and varied, and provides an infinitely flexible format for expression and communication. It is particularly well suited for sentiment communication and social greetings for all different types of occasions. The ability to use sound and animated or video imagery, in combination with printed matter such as with conventional printed greeting cards significantly enhances the communicative value of social and relational greetings. Although some efforts have been made at combining traditional printed communication and greetings with digital technology and content, the prior art does not include devices or combinations which are sufficiently versatile to accommodate interactive digital content, and which will maintain their utility and entertainment value long after the initial communication.

### SUMMARY OF THE INVENTION

The present disclosure and related inventions include social expression products such as greeting cards and other sentiment or messaging products and which include or are combined with one or more digital devices. In one particular embodiment, there is a built-in video gaming device which includes a liquid crystal display (LCD) or other type of display, a digital circuit including a microprocessor, digital data storage, power, and controls such as game control buttons and power on/off button. The digital circuit is contained within a protective structure of the greeting product such as a card, for example within multiple panels of a greeting card, or otherwise packaged and protected in combination with a card. A recipient of the card holds the greeting card and controls the game by pushing buttons that are built into the card, and the display is visible through one or more pages of panels of the card.

In accordance with a representative embodiment of the disclosure and related inventions, there is provided an interactive greeting card which has a greeting card body having three main panels and four side panels; a protective housing substantially concealed within the greeting card body; a video game module including at least one video game, a video screen and one or more control buttons, the video game module being surrounded by the protective housing and wherein the video screen and one or more control buttons can be accessed through one or more apertures in the greeting card body.

### DESCRIPTION OF THE DRAWINGS

FIG. 1 is a perspective view of a preferred embodiment of the greeting card of the present invention.

FIG. 2 is a front view of the protective housing and electronic components.

FIG. 3 is a die cut of the outer greeting card construct.

FIG. 4 is a perspective view of an alternate embodiment of the greeting card of the present invention.

### DETAILED DESCRIPTION OF PREFERRED AND ALTERNATE EMBODIMENTS

The greeting cards and social expression products with video gaming features of the present disclosure and related inventions have, in certain representative embodiments, multiple panel paper or paper-board greeting card structures which house, either partially or entirely, a complete video game circuit including a display, controls and sound and/or vibration. The greeting card serves as a greeting and gift all in one.

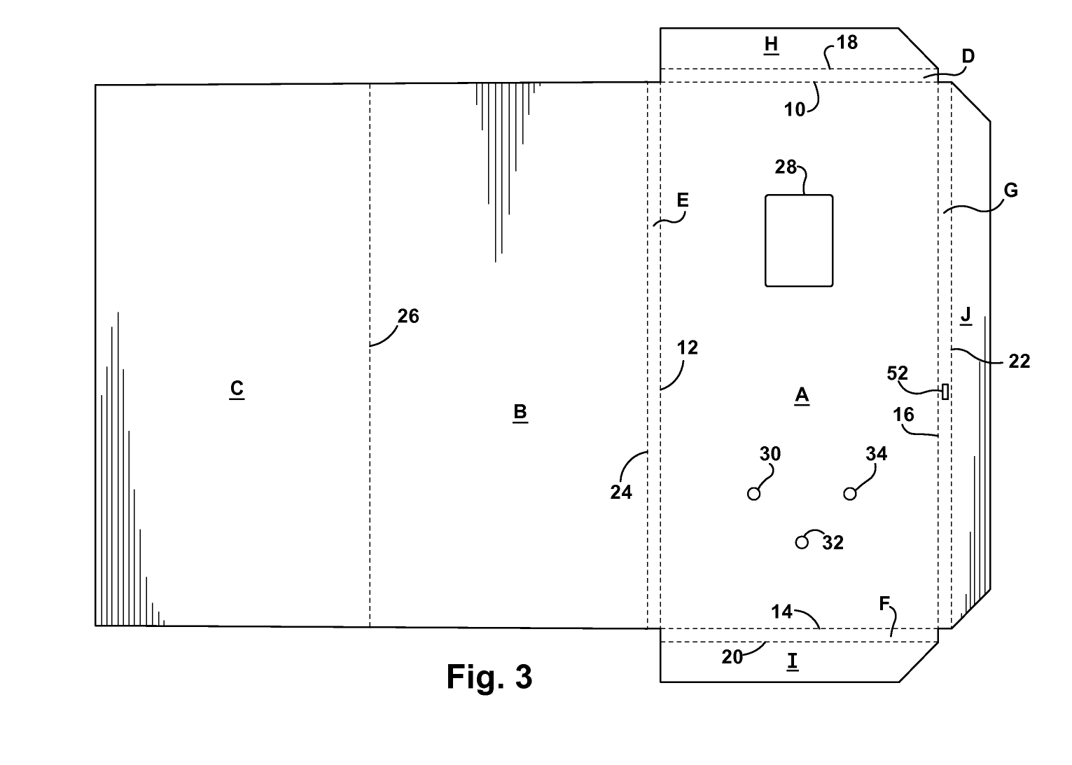

As shown in FIG. 3, the greeting card body includes three main panels A, B, C, that are connected along various fold lines. Each panel is generally rectangular in shape with each panel having approximately the same length and width dimensions. Although a rectangular greeting card is described herein and shown in the Figures, the greeting card 100 may alternatively take alternative shapes and different greeting card shapes are considered to be within the scope of the present invention. A first main panel A, which serves as the front cover of the greeting card, contains various cut-outs or openings thereon to accommodate the video game screen and control buttons which will be visible and perhaps protrude from the front face of the greeting card. One such cut-out or opening 28 is aligned with the placement of the video screen within a protective structure which surrounds the various components of the video game. A set of openings 30, 32, 34 is also contained in a lower section of first main panel A to accommodate various control buttons. The number of control buttons and therefore the number of openings for control buttons may vary. Four side panels, D, E, F and G extend from each of the four edges of panel A along fold lines 10, 12, 14 and 16. The four side panels D, E, F and G, wrap around the sides of the protective structure. Side panel G contains a small opening 52 thereon to accommodate an on/off switch located along a side wall of the greeting card. Side panels D, F and G each contain a flange H, I, J, which is connected to the side tab along fold lines 18, 20 and 22. The flanges H, I and J, attach to the back side of the protective structure, adhesively or otherwise. A second main panel B serves as a back cover of the protective structure and a left inside panel of the greeting card. Second panel B is attached to side tab E along fold line 24 and to third main panel C along fold line 26. Panel C serves as the back cover of the greeting card and a right inside panel of the greeting card. Both sides of each panel A, B, C, may contain printed indicia, pictures, photographs and various embellishments which add to the communicative or social value of the greeting card.

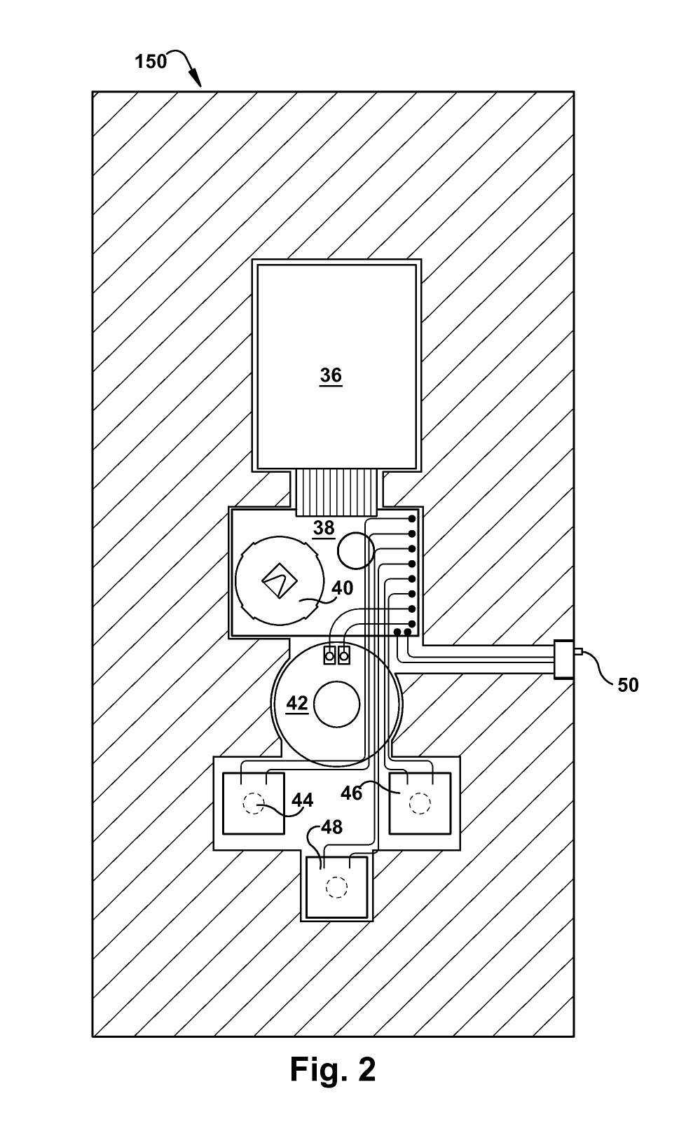

The protective structure 150 that houses and protects the video game components, shown in FIG. 2, is of approximately the same shape, length and width as the main greeting card panels A, B, C. The depth of the protective structure 150 is approximately the same as the depth of side panels D, E, F, G, or in a preferred embodiment, approximately ¼ inches. It is preferably made of cardboard but can be made of plastic, foam, or any other sturdy protective material. The protective structure 150 may comprise a single piece of cardboard or two separate pieces of cardboard which are stacked atop one another and surrounding the video game components. Various cut-outs or openings in various sizes and shapes are contained in the structure 150 to accommodate each of the components of the video game. The protective structure 150 is substantially enclosed within the greeting card body, and more specifically, by main greeting card panels A, B and side panels D, E, F, G.

Also shown in FIG. 2, the video game components may include, but are not limited to, a video game screen 36, preferably an LCD screen, a printed circuit board (PCB) 38 with controller and microprocessor, a power source 40, a memory device, speaker 42, control buttons 44, 46, 48 and related circuitry. The video game may additionally include other components generally used in the operation of hand held video games, as would be known to one of skill in the art. The components are secured within the various openings in the protective structure 150 and are concealed between panels A and B of the greeting card body. The protective structure 150 is thicker than all of the game components so that they sit within or flush with the structure 150. The components may be attached, adhesively or otherwise, to the protective structure 150 and/or one or more of the greeting card panels. One or more control buttons may be accessible through the front of the greeting card.

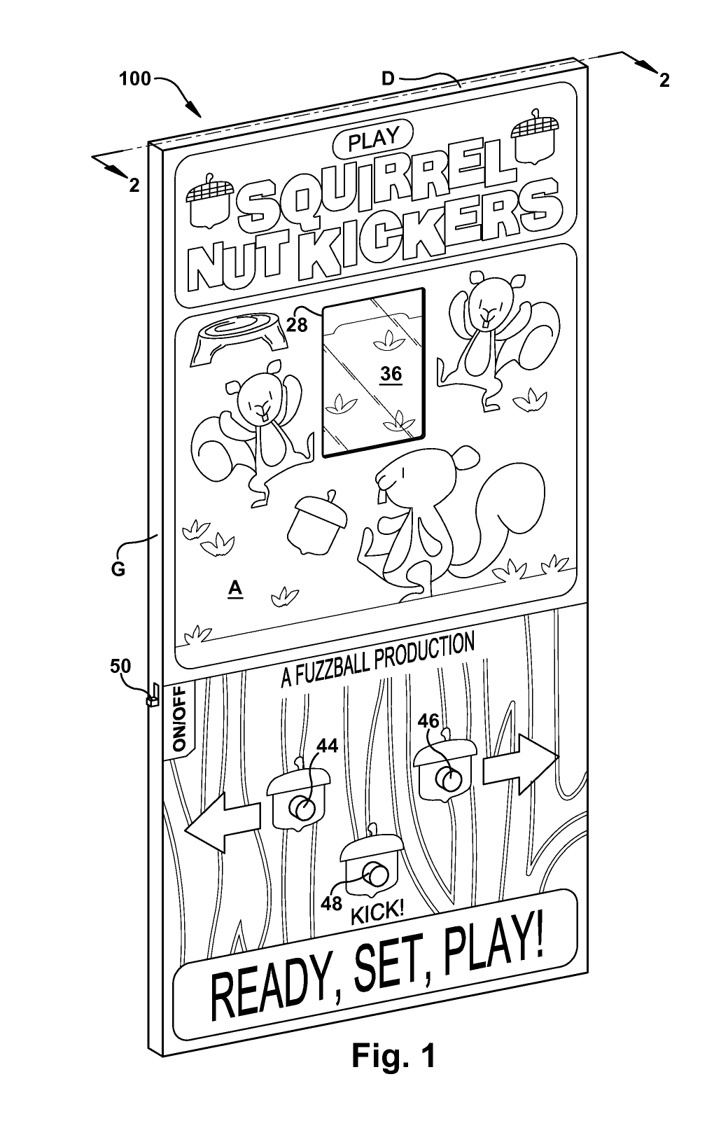

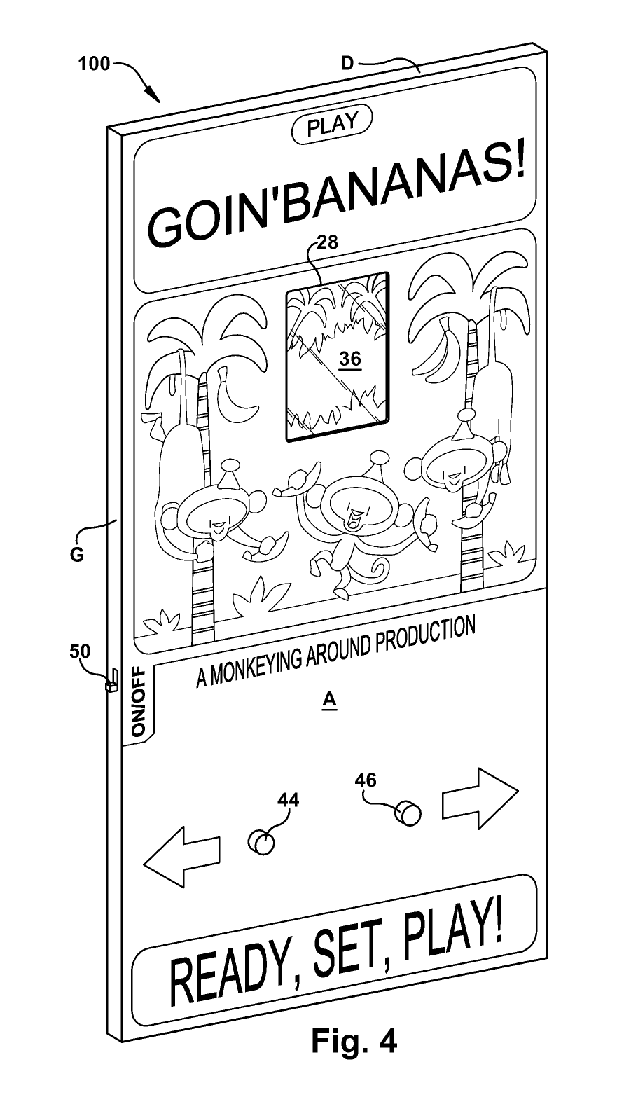

In a preferred embodiment, shown in FIG. 1, the video game is accessed directly through the front face of the greeting card or panel A. The video screen 36 is visible through an opening 28 in panel A and one or more control buttons 44, 46, 48 are accessed through one or more additional openings 30, 32, 34 in panel A. The control buttons 44, 46, 48 are preferably located near a bottom section of the greeting card 100 so that a user or recipient of the card can hold the card while pressing the control buttons with his/her thumbs. Each control button 44, 46, 48, preferably made of rubber, extends outward from the face of the card 100 so they are easily accessed through the greeting card construct. A single control button 48 may be used to “fire”, “kick”, “jump” or perform other such actions in relation to the video game. Alternatively, there may be two control buttons 44, 46 (as shown in FIG. 4) that control the movement of the video game character or player. One button 44 may move the character to the left or in an upward direction and the other 46 may move the character to the right or in a downward direction. In still another embodiment, three control buttons may be used (as shown in FIG. 1), a first 44 to move left or up, a second 46 to move right or down and a third 48 to “fire”, “kick”, “jump” or perform other such action movement. The control buttons may be labeled with arrows or directive words. Various sounds can also be coordinated with and triggered by pressing the control buttons, winning or losing the game. Background sounds, spoken words, songs or music can also be played while the video game is being played or while the power is turned on. The video screen 36 displays the video game, which may be in color or black and white. It may include various animated characters and a variety of game themes. For example, the game may include a monkey catching bananas before they fall to the ground, a squirrel trying to throw acorns past another squirrel, or a mermaid trying to avoid falling jelly fish. Two or more separate video games may exist in memory within the greeting card so that the user or card recipient may choose from a list of video games contained in the greeting card. An additional or existing control button may be used to scroll through the list and select a video game for playing. An on/off switch 50 may also be located on the front face of the greeting card or preferably, along one of the side walls of the card, such as in side panel G, as shown in FIG. 1. The on/off switch 50 allows the user or card recipient to control when the game is turned on and also to conserve the life of the battery. Alternatively, the greeting card 100 may be configured so that the video game may be accessed through an inside panel of the greeting card. In this case, the video game may utilize a slide switch located between two greeting card panels so that the game is automatically turned on when the user or card recipient opens the greeting card by moving the front panel away from the greeting card.

In another embodiment, the greeting card may additionally include a port, such as a USB port or SD card slot which will accept and read from an external memory source such as a personal computer, a zip drive, an SD card, or other such device. Various video games, which are compatible with the greeting card video game system, may be uploaded and saved within the device so that the user or card recipient can select from two or more video games. The USB port or SD card slot may additionally be operative to upload digital photos, digital audio files or other such data. As described above, an additional or existing control button may be used to select from a list of video games existing in memory within the greeting card, or to move through various digital photos or slideshow or to select a digital audio file for playback through the speaker.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. An interactive greeting card comprising:
a greeting card body having three main panels and four side panels;
a protective housing substantially concealed within the greeting card body;
a video game module comprising at least one video game, a video screen and one or more control buttons, the video game module being surrounded by the protective housing;
wherein the video screen and one or more control buttons can be accessed through one or more apertures in the greeting card body.

2. The interactive greeting card of claim 1 further comprising a manual on/off switch which is accessed through the greeting card body.

3. The interactive greeting card of claim 1, wherein the video screen and one or more control buttons is visible and accessible through a front face of the greeting card.

4. The interactive greeting card of claim 1, wherein the greeting card has two control buttons.

5. The interactive greeting card of claim 1, wherein the greeting card has three control buttons.

6. The interactive greeting card of claim 1, wherein the video game module contains two or more video games.

7. The interactive greeting card of claim 1 further comprising a USB port or SD card slot for uploading data from an external memory source.

8. An interactive greeting card comprising:
a substantially rectangular greeting card body having a first main panel, a second main panel, a third main panel, a first side panel, a second side panel, a third side panel and a fourth side panel, the panels being connected along a plurality of fold lines;
a video game module comprising a circuit board with a microprocessor, a memory storage device, at least one video game, a power source, an on/off switch, a video screen, one or more control buttons; and
a protective housing which substantially surrounds the video game module, the protective housing substantially enclosed within the greeting card body;
wherein the greeting card body contains at least three apertures thereon through which the video screen, one or more control buttons, and on/off switch are accessed.

9. The interactive greeting card of claim 8, wherein the video screen and one or more control buttons is accessed through a front cover of the greeting card.

10. The interactive greeting card of claim 8, wherein the on/off switch is accessed through one of the side panels of the greeting card.

11. The interactive greeting card of claim 8, wherein the protective housing is made of cardboard.

12. The interactive greeting card of claim 8, wherein the protective housing is made of foam.

13. The interactive greeting card of claim 8, wherein the thickness of the greeting card is approximately ¼ inch.

14. The interactive greeting card of claim 8, wherein the video game module contains two control buttons.

15. The interactive greeting card of claim 8, wherein the video game module contains three control buttons.

16. The interactive greeting card of claim 8 further comprising a USB port or SD card slot for uploading data from an external memory source.

17. An interactive greeting card comprising:
a greeting card body having a plurality of panels connected by a plurality of fold lines, the plurality of panels creating an enclosed internal cavity;
a video game module contained within the internal cavity of the greeting card body, the video game module operative to display interactive video game graphics on a video display screen, portions of the video game being controlled by a user pressing one or more control buttons contained within the greeting card body,
wherein the video display screen and one or more control buttons are visible and accessible through a front surface of the greeting card body.

18. The interactive greeting card of claim 17 further comprising a protective housing which is concealed and contained within the greeting card body and which substantially surrounds the video game module.

19. The interactive greeting card of claim 17 further comprising an on/off switch accessible through the greeting card body.

20. The interactive greeting card of claim 17, wherein the video game module is operative to play sound.

21. The interactive greeting card of claim 17, wherein the interactive greeting card contains two control buttons.

22. The interactive greeting card of claim 17, wherein the interactive greeting card contains three control buttons.

23. The interactive greeting card of claim 17 further comprising a USB port or SD card slot for uploading data from an external memory source.
